(19) United States
(12) Patent Application Publication
(10) Pub. No.: US 2013/0159376 A1
(43) Pub. Date: Jun. 20, 2013

(54) SYSTEMS AND METHODS FOR A COMPUTING RESOURCE BROKER AGENT

(71) Applicant: Charles Moore, Mountain View, CA (US)

(72) Inventor: Charles Moore, Mountain View, CA (US)

(73) Assignee: Charles Moore, Mountain View, CA (US)

(21) Appl. No.: 13/715,835

(22) Filed: Dec. 14, 2012

Related U.S. Application Data
(60) Provisional application No. 61/576,127, filed on Dec. 15, 2011.

(51) Int. Cl. H04L 29/08

(52) U.S. Cl. CPC H04L 67/10
USPC 709/202

(57) ABSTRACT

A resource broker agent may be configured to monitor computing resources available on a computing device. The resource broker agent may be further configured to request additional computing resources in response to detecting a request to perform a computing task that cannot be adequately performed with the computing resources currently available on the computing device. The additional computing resources may be requested from one or more remote resource providers via a network. The additional computing resources may comprise remote execution of portions of the computing task. The resource broker agent may be further configured to perform the requested computing task by use of a virtualized computing environment of the computing device.

### CROSS-REFERENCE TO RELATED APPLICATIONS

This application claims priority to U.S. Provisional Patent Application No. 61/576,127, entitled “System or Method for a Computing Resource Broker Agent,” filed on Dec. 15, 2011.

### TECHNICAL FIELD

This disclosure relates to computing resources, and, particularly, to systems and methods for brokering resources for computing devices.

### BRIEF DESCRIPTION OF THE DRAWINGS

This disclosure includes and references the accompanying drawings, which provide a more particular description of the embodiments disclosed herein. The disclosure, however, is not limited to the particular embodiments depicted in the figures. The teachings of the disclosure may be utilized and/or adapted to other embodiments and/or changes may be made to the disclosed embodiments, without departing from the scope of the disclosure.

FIG. 1A depicts one embodiment of a system for brokering computing resources;

FIG. 1B depicts another embodiment of a system for brokering computing resources;

FIG. 2 is a flow diagram of one embodiment of a method for brokering computing resources;

FIG. 3 is a flow diagram of another embodiment of a method for brokering computing resources;

FIG. 4A depicts one embodiment of a resource broker agent;

FIG. 4B depicts one embodiment of a resource state data structure;

FIG. 5 depicts one embodiment of a resource broker agent operating on a computing device; and

FIG. 6 is a flow diagram of another embodiment of a method for brokering computing resources.

### DETAILED DESCRIPTION

In today's computing environment new computer devices, operating systems, software applications, and services are being made available to business and consumers at a rapid pace. Also increasing at a rapid rate is the size, required resources, and complexity of these applications and services. The result is the rising cost for businesses and consumers to either keep their devices up to date or to purchase new devices in order to utilize the services and applications that are available to them. In today's computing environment there also exists rapidly increasing amounts of remote or cloud-based computing resources that can be accessed over public or private networks.

Presently there is no method of accessing, from every available computing device, all of the applications and services that are available to businesses and consumers.

A resource broker agent may be configured to monitor the resources of a computing device and compares them, at runtime, to the resource requirements of the tasks attempting to be run on that device. The resource broker agent automatically identifies and brokers any additional resources required for the computing device to perform the desired tasks.

Some applications may be capable of detecting, at runtime, the need for updates, plug-ins, and/or extensions. However, such applications typically require that all of the components (updates, plug-ins, extensions as well as the applications and operating systems themselves) are compatible with the requesting computing device, and must operate within the resource limitations of the computing device. In some embodiments, the resource broker agent is configured to utilize resources that do not reside, and may never reside, on the computing device. Accordingly, the resource broker agent may enable the computing device to perform a wide variety of computing tasks, regardless of whether the computing device has sufficient local computing resources required to do so.

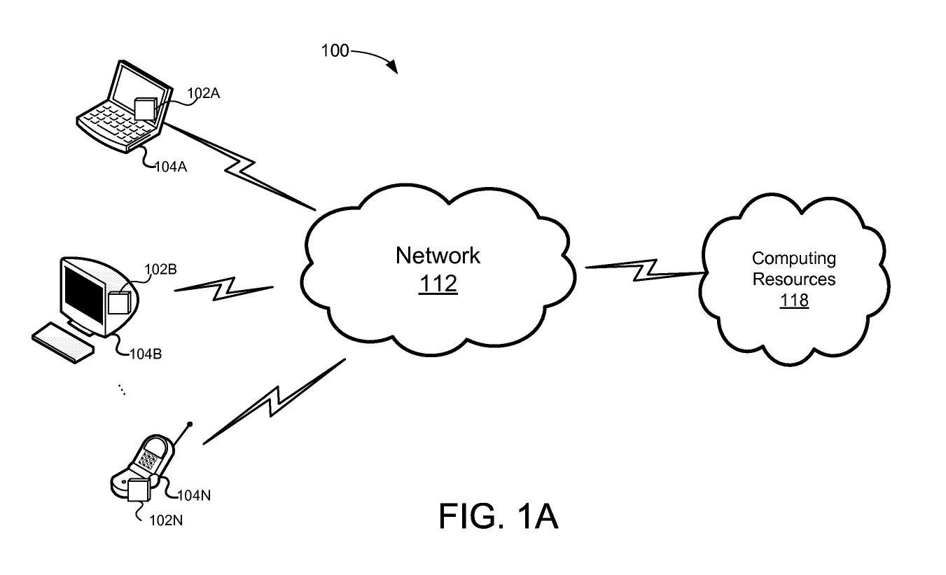

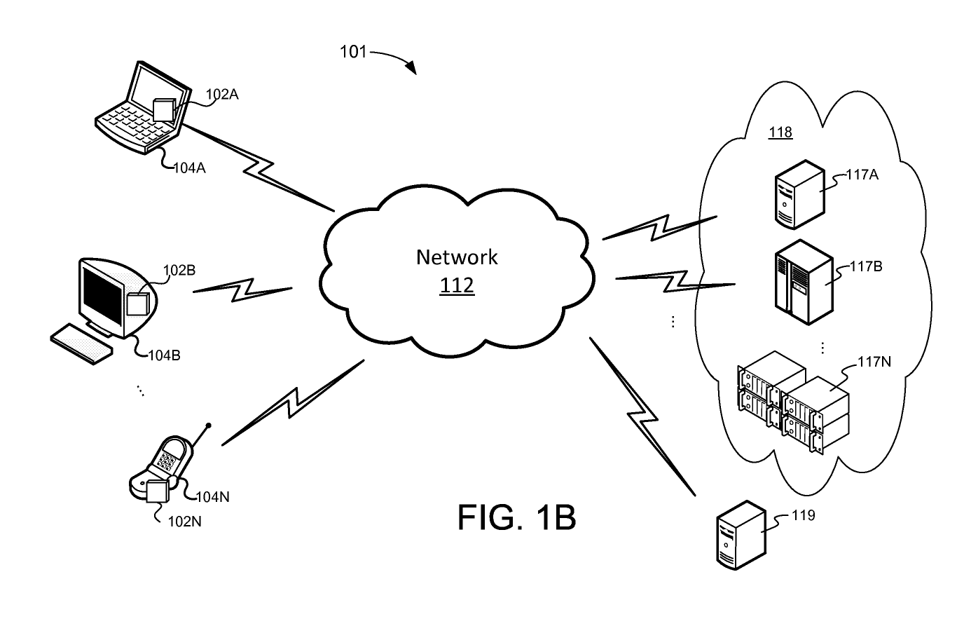

FIG. 1A depicts one embodiment of a system 100 for brokering computing resources. A resource broker agent 102 may be configured to operate on a computing device 104A-N. The computing devices 104A-N may include, but are not limited to: mobile computing devices 104A (e.g., laptop computers, notebook computers, tablet computers, personal digital assistants, or the like), desktop computing devices 104B (e.g., personal computers, workstations), servers, kiosks, miniframes, mainframes, diskless terminals, super computers, set-top boxes, and/or mobile communications devices 104N, such as smart phones, or the like.

The resource broker agent 102 may be adapted for use on the different computing devices 104A-N and/or within different computing environments. The resource broker agent 102 may include, but is not limited to: a software application, an extension to a software application, an extension of the operating system of the computing device 104A-N, part of the base operating system of the computing device 104A-N, hardware components (e.g., a microchip, a hardware accessory or peripheral of the computing device 104A-N, or the like), a hardware device located on a local or remote network 112, or any combination thereof in software or hardware form.

The resource broker agent 102 may be configured to broker access to and/or delivery of computing resources 118 as needed (e.g., in real-time and/or in response to requests to perform computing tasks that require access to additional computing resources 118). The computing resources 118 may be accessible via the network 112 and/or may be local to the computing device 104A-N (e.g., may be accessible through a virtual computing environment, by reallocating resources on the computing device 104A-N, or the like). The network 112 may comprise an Internet-Protocol (IP) network (e.g., the Internet), one or more public networks, one or more private networks, or the like. The resource broker agent 102 may be configured to identify resources needed to perform a requested computing task and to request and/or broker access to the identified computing resources 118.

In some embodiments, the resource broker agent 102 is configured to detect and/or monitor computing resources available on a computing device 104A-N. As used herein, a computing resource refers to any resource for executing a computing task; computing resources may include, but are not limited to: memory resources, storage resources, input/output (I/O) resources, processing resources, graphics resources (e.g., graphics processing resources, graphics memory, etc.), libraries (e.g., software modules, applications, extensions, plugins, Application Programming Interfaces (APIs), etc.), display resources, operating system resources, or the like.

The resource broker agent 102 may be further configured to detect requests to perform computing tasks on the computing device 104A-N. As used herein, a request may refer to an indication (e.g., a command) from a user or other processes to perform a computing task on a computing device 104A-N. A computing task may include, but is not limited to: running an application, starting a service, opening and/or editing a file, performing a data processing operation (e.g., query, sort, etc.), performing an I/O operation, performing a storage operation, or the like. The resource broker agent 102 may be configured to evaluate requested computing tasks to determine whether the computing task can be performed using the computing resources currently available on the computing device 104A-N. In some embodiments, the resource broker agent 102 is configured to compare computing resources needed to perform the requested computing task to available computing resources on the computing device 104A-N. The resource broker agent 102 may be configured to request additional computing resources 118 in response to determining that the computing resources available at the computing device 104A-N at the time are not sufficient to perform the requested computing task (and/or are not sufficient to perform the requested computing task at a required quality of service). The resources requested by the resource broker agent 102 may comprise computing resources configured to allow the computing device 104A-N to implement the requested computing task and/or may comprise requesting remote execution of the computing task.

FIG. 1B depicts another embodiment of a system 101 for brokering computing resources. In the FIG. 1B embodiment, the broker agent 102 may be configured to broker access to computing resources 118 from one or more resource providers 117A-N. Brokering access to computing resources 118 may comprise transmitting one or more requests to one or more of the resource providers 117A-N. The request(s) may identify the type, quantity, format, access method, and/or delivery method of the requested computing resources 118. The request(s) may further comprise an offer for consideration in exchange for access to the requested computing resources 118 (e.g., a payment). The payment amount may be brokered in real-time between the resource broker agent 102 and a respective resource provider 117A-N and/or may be pre-determined based on a catalog of services offered by the resource providers 117A-N and/or policies of the resource broker agent 102. In some embodiments, brokering access to the computing services 118 may comprise notifying a user of the need for the computing service 118 and/or requesting acceptance terms for access to the computing services 118 (e.g., payment, delivery, quality of service conditions, and so on).

In some embodiments, the resource broker agent 102 may be configured to maintain a catalog of resource providers 117A-N and/or information pertaining to the computing services 118 provided thereby. The resource broker agent 102 may be configured to query one or more of the resource providers 117A-N to obtain and/or update catalog information. Alternatively, or in addition, the resource broker agent 102 may access catalog information pertaining to the resource providers 117A-N by use of a discovery service 119.

The resource broker agent 102 may be configured to display information pertaining to the computing tasks available for execution on the computing device 104A-N and/or resource providers 117A-N (per the catalog information). The resource broker agent 102 may display applications, services, and/or other computing tasks that may be implemented by use of the computing resources of the computing device 104A-N, by use of a virtual computing environment on the computing device 104A-N, and/or by use of computing resources 118 and/or resource providers 117A-N. The computing tasks may include applications installed on the computing device 104A-N, applications that are installed on one or more virtual machines of the computing device 104A-N, and/or applications that are only available through one or more of the resource providers 117A-N. The resource broker agent 102 may provide a launcher configured to invoke one or more of the applications, as described herein.

In some embodiments, the resource providers 117A-N may be provided by one or more third-party entities. Alternatively, or in addition, one or more of the resource providers 117A-N may be owned and/or controlled by a user of the computing device 104A-N. For example, a user may have a desktop computing device 104B that is used as a resource provider for a less-powerful mobile computing device 104N.

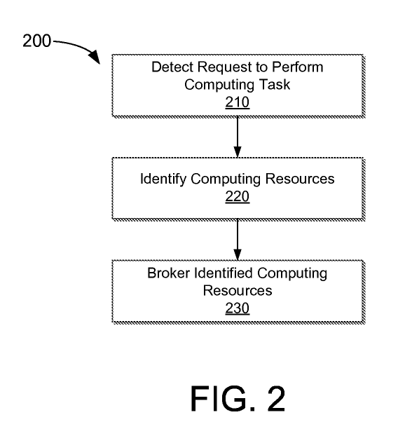

FIG. 2 is a flow diagram of one embodiment of a method 200 for brokering computing resources. Step 210 may comprise detecting a request to perform a computing task on a computing device 104A-N. Step 210 may comprise monitoring requests and/or commands on the computing device 104A-N, as described above. Step 210 may be performed by a resource broker agent 102 operating on the computing device 104A-N. The request detected at step 210 may be initiated by a user, process, or other entity operating on the computing device 104A-N and/or operating remotely from the computing device 104A-N (e.g., in a remote desktop session, or the like). The request may be detected by the resource broker agent 102 operating on the computing device 104A-N and/or by another process and/or entity.

Step 220 may comprise identifying computing resources needed to perform the requested computing task. Step 220 may comprise determining that the requested computing task cannot be performed by use of the computing resources currently available at the computing device 104A-N (and/or cannot be performed with an adequate quality of service with currently available computing resources) by, inter alia, evaluating currently available computing resources compared to the computing resources needed to implement the requested computing task. The evaluation may comprise determining whether the computing device 104A-N has sufficient free memory, storage, I/O resources, processing resources, graphical processing resources, or the like. The evaluation may further comprise determining whether the computing device 104A-N comprises libraries (e.g., software, applications, operating systems, and so on) required to perform the requested computing task, which may comprise evaluating dependencies of the computing task, supported operating systems, operating system versions, availability of libraries, and so on.

Step 230 may comprise brokering access to additional computing resources 118 as identified at step 220. Step 230 may comprise brokering access to the computing resources 118 with one or more resource providers 117A-N. Step 230 may further comprise communicating one or more requests to one or more resource providers 117A-N via a network 112. The request(s) may indicate the resources required by the computing device 104A-N, a delivery mechanism for the requested computing resources 118, a timeframe for the requested computing resources 118, quality of service requirements, and so on. The one or more requests may further comprise an offer indicating consideration to be provided in exchange for access to the requested computing resources 118.

In some embodiments, Step 230 comprises providing access to the brokered computing resources 118 and/or implementing the requested computing task by use of the brokered computing resources 118. Implementing the requested computing task may comprise implementing portions of the computing task on the computing device 104A-N by use of the brokered computing resources 118 (resources provided by one or more resource providers 117A-N). Alternatively, or in addition, implementing the requested computing task may comprise implementing portions of the requested computing task (and/or the entire computing task) on one or more of the resource providers 117A-N.

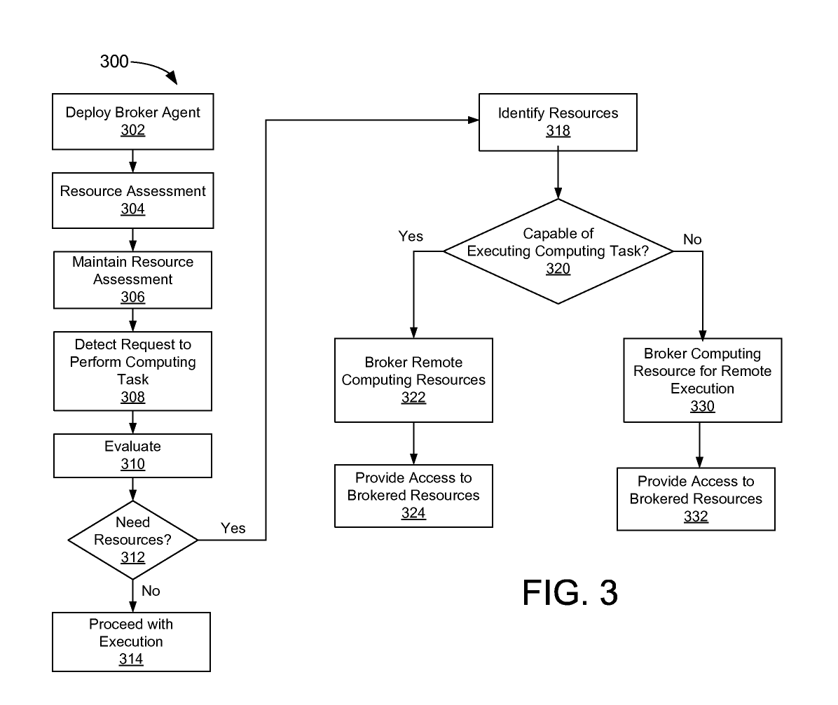

FIG. 3 is a flow diagram of another embodiment of a method 300 for brokering computing resources. Step 302 may comprise deploying the resource broker agent 102 on a computing device 104A-N, which may comprise installing one or more software components or modules on the computing device 104A-N, adding hardware and/or peripheral devices to the computing device 104A-N, or the like.

Step 304 may comprise performing a resource assessment of the computing device 104A-N. Step 304 may comprise identifying the computing resources available on the computing device 104A-N, including, but not limited to: hardware resources (e.g., memory, storage, I/O, processing, graphics, etc.), software resources (e.g., applications, operating system, versioning information, libraries, etc.), and so on. Step 304 may further comprise determining resource availability and so on, as described above. Step 306 may comprise populating a resource state data structure with the results of the resource assessment of step 304. The resource state data structure may track resource availability on the computing device 104A-N. As described in further detail below, the resource state data structure may comprise information pertaining to the local computing resources of the computing device 104A-N, current resource utilization levels (e.g., currently running applications and/or services), and so on.

Step 308 may comprise detecting a request to perform a computing task on the computing device 104A-N, as described above. Step 308 may comprise monitoring requests and/or commands on the computing device 104A-N by use of the resource broker agent 102 and/or other monitoring process or entity. Step 308 may comprise monitoring system calls within an operating system of the computing device 104A-N, monitoring user activity, monitoring resource usage, monitoring messaging systems, and the like.

Step 310 may comprise evaluating the requested computing task detected at step 308. The evaluation may be based on the available computing resources of the computing device 104A-N, such as current resource utilization levels. The evaluation may comprise comparing the resources required to implement the computing task to the computing resources available on the computing device 104A-N. The evaluation of step 310 may comprise comparing available memory, storage, I/O, processing resources, graphics resources, and the like, to resources required to execute the requested computing task. The resource requirements of the computing task may be based on pre-determined information regarding an application and/or service pertaining to the command (e.g., resource requirements of a particular application). The resource requirements may also be based on the particular instance of the command, such as the size and/or complexity of a file to be processed by the command (e.g., the size and/or complexity of an image to be opened in an image processing application).

The evaluation of step 310 may further comprise evaluating hardware and/or software dependencies, such as whether the computing device 104A-N comprises an operating system, libraries, and/or other components required by the computing task 104A-N. Step 310 may further comprise evaluating the availability of computing resources based on other component tasks running on the computing device 104A-N. Accordingly, the evaluation of step 310 may be based on the resource utilization table (and/or other data structures) maintained by the resource broker agent 102.

In some embodiments, the evaluation of step 310 is based on user preferences, such as quality of service preferences, and the like. For example, a quality of service preference may comprise requesting and/or requiring computing resources in addition to the “minimum requirement” of the requested computing task to ensure that the requested computing task can run on the computing device 104A-N with an acceptable quality of service.

Step 312 may comprise the resource broker agent 102 determining whether the computing device 104A-N can execute the requested computing task without accessing additional computing resources 118, based on the evaluation of step 310. If the evaluation of step 310 indicates that the requested computing task can be executed without brokering additional computing resources 118, the flow continues at step 314; otherwise, the flow continues at step 318.

Step 314 may comprise proceeding with execution of the requested computing task on the computing device 104A-N without brokering additional computing resources 118. Step 314 may further comprise updating a resource state data, which may comprise identifying the computing resources consumed by the requested computing task, decrementing an indicator of available computing resources, and the like.

Step 318 may comprise identifying additional computing resources needed to execute the requested computing task. Step 318 may comprise comparing resources required to execute the computing task to available computing resources (e.g., using a resource allocation table). Step 318 may further comprise identifying resources needed to ensure that the computing task can be executed at an acceptable quality of service. The resources needed to execute the command may, therefore, be based on the resources of the computing device 104A-N, user and/or system preferences, and/or current resource utilization levels (e.g., resource state data structure).

As disclosed above, the additional computing resources identified at step 318 may include, but are not limited to: memory resources, storage resources, I/O resources, processing resources, graphics processing resources, operating system resources, libraries, APIs, remotely executed tasks or applications, operating system extensions, application extensions, plug-ins, emulation software, software updates, remotely executed tasks or applications delivered or presented in a format compatible with the computing device 104A-N, other computing resources that are not available to the computing device 104 at that time, and the like.

Step 320 may comprise determining whether the computing device 104A-N is capable of executing the requested computing task utilizing the additional resources identified at step 318. The determination of step 320 may be based on capabilities of the computing device 104A-N, compatibility of the computing device 104A-N with the requested computing task (e.g., computing device 104A-N operating system, processor architecture, etc.), and so on. If the computing device 104A-N is capable of implementing the command with additional computing resources, the flow continues to step 322; otherwise, the flow continues to step 330.

Step 322 may comprise brokering access to additional computing resources 118 needed to perform the requested computing task as identified at step 318. Step 322 may comprise requesting access to the computing resources 118, as described above. The computing resources 118 may be requested from one or more resource providers 117A-N via the network 112. Brokering access to the computing resources 118 may further comprise determining a delivery and/or access format for the resources.

Step 324 may comprise providing for delivering the brokered computing resources 118 to the computing device 104A-N for use in performing and/or executing the requested computing task. The brokered computing resources 118 may be delivered via the network 112 using the delivery and/or access format brokered at step 322. Step 324 may further comprise updating the resource state data structure to indicate execution of the requested computing task, as described above.

Referring back to step 320, if the resource broker agent 102 determines that the requested computing task cannot be executed at the computing device 104A-N (even with additional computing resources 118), the flow may continue to step 330. Step 330 may comprise brokering remote execution of the requested computing task at one or more resource providers 117A-N. Brokering remote execution may comprise the resource broker agent 102 accessing one or more resource providers 117A-N via the network 112 (or other communication mechanism). Step 330 may further comprise brokering a delivery and/or access format for the remote execution, which may include, but is not limited to: remote display, such as Remote Framebuffer (RFB), virtual network computing (VNC), Remote Desktop Protocol (RDP), or the like, Remote Procedure Calls (RCP), Remote Method Invocation (RMI), Simple Object Access Protocol (SOAP), or the like. Accordingly, step 330 may comprise determining a desired viewing format for the remote execution using one or more of the delivery and/or access mechanisms.

Step 332 may comprise providing for execution of the requested computing task at one or more resource providers 117A-N per the remote execution brokering of step 330. Step 332 may comprise providing for displaying an interface and/or result of the remotely executed computing task at the computing device 104A-N. Step 332 may further comprise updating the resource state data structure, as described above.

Referring back to FIG. 1B, the resource broker agent 102 may be configured to broker access to computing resources 118 with one or more resource providers 117A-N, which may comprise transmitting one or more requests to the resource providers 117A-N and/or establishing one or more communications channels with the resource providers 117A-N via the network 112. The resource broker agent 102 may be configured to secure communication with the resource providers 117A-N by use of data encryption, device authentication, user authentication, third-party authentication, and/or the like.

In some embodiments, the resource broker agent 102 is managed by a user of the computing device 104A-N using, inter alia, settings, preferences, and/or the like. Alternatively, or in addition, the resource broker agent 102 may be managed by a third party management entity. Management of the resource broker agent 102 may comprise identifying resource providers 117A-N from which the resource broker agent 102 may request additional computing resources 118. The resource providers 117A-N may be identified by name, network address or identifier, or the like. In some embodiments, identifying a resource provider 117A-N may comprise importing a digital certificate (or other credential) of the resource provider 117A-N, providing a credential and/or identifier to the resource provider 117A-N, or the like. Management of the resource broker agent 102 may be used to establish and/or enable custom catalogs of services, custom resource broker agent 102 settings or other features and may be provided as a paid service to a user of the computing device 104A-N.

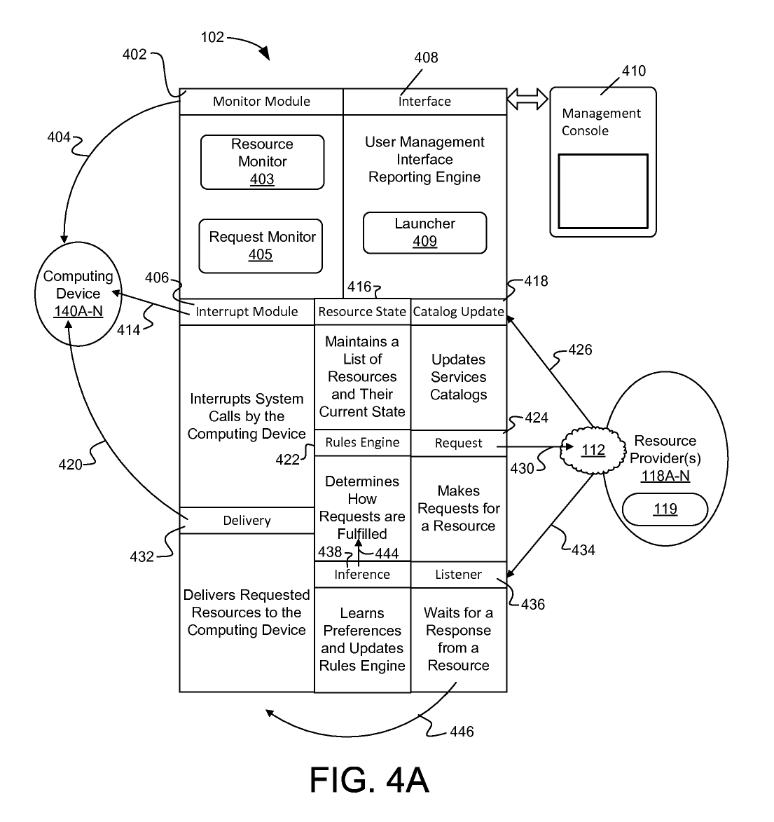

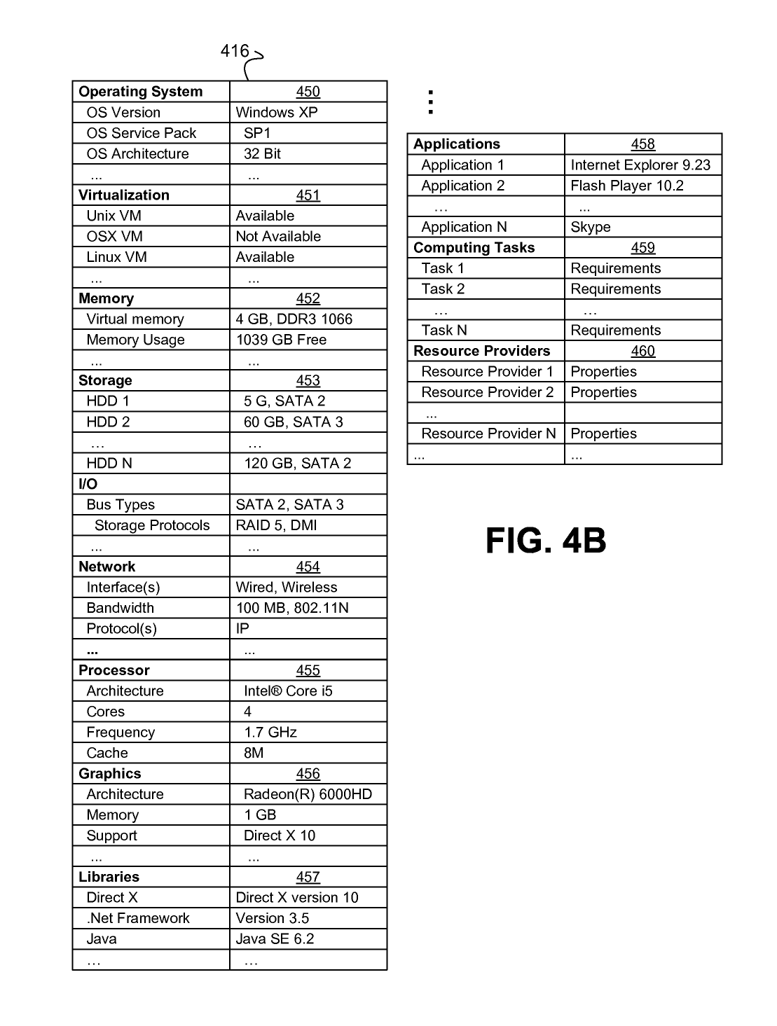

FIG. 4A depicts one embodiment of a resource broker agent 102. The resource broker agent 102 may comprise a monitor module 402. The monitor module 402 may comprise a resource monitor module 403 configured to monitor 403 computing resources of the computing device 104A-N. The resource monitoring module 404 may be configured to monitor computing resources available on the computing device 104A-N. The monitor module 402 may further comprise a request monitor module 405 configured to monitor and/or detect requests to perform one or more computing tasks on the computing device 104A-N (e.g., user commands). Accordingly, the resource monitor 403 and/or request monitor module 405 may be configured to operate within an operating system of the computing device 104A-N and/or may be communicatively coupled to the operating system.

The resource broker agent 102 may further comprise an interrupt module 406 configured to intercept and/or interrupt 414 requests to perform computing tasks on the computing device 104A-N (e.g., user commands). The interrupt module 406 may be configured to detect and/or interrupt requests to perform computing tasks within the operating system of the computing device 104A-N (e.g., kernel-level of the operating system).

The resource broker agent 102 may further comprise a resource state data structure 416 configured to track the computing resources available on the computing device 104A-N, current utilization levels, and so on. As described above, the resource state data structure 416 may comprise information pertaining to the capabilities of the computing device 104A-N (e.g., memory, storage, I/O, processing, graphics, etc.), software services available on the computing device 104A-N (e.g., operating system(s), hypervisors, virtual machines, applications, application modules, libraries, versions, service packs, etc.), and so on. The resource state data structure 416 may further comprise information pertaining to current resource utilization rates on the computing device 104A-N, other applications executing on the computing device 104A-N, and so on. The resource state data structure 416 may further indicate the availability of virtual computing resources, such as hypervisors, virtual machines, and so on. For example, a computing device 104A-N running a Microsoft Windows® operating system may comprise a virtual machine configured to provide for executing computing tasks and/or applications configured to operate on a Unix® operating system. In some embodiments, the resource broker agent 102 may be configured to publish and/or invoke applications within one or more of the virtual machines.

FIG. 4B depicts one embodiment of a resource state data structure 416. The data structure 416 may be implemented as a table comprising a plurality of fields and/or sections. The fields 402 may comprise attribute-value pairs corresponding to computing resources available on the computing device 104A-N and/or resource consumption on the computing device 104A-N. The resource state data structure 416 may comprise one or more fields 450 corresponding to the operating system of the computing device 104A-N, including fields indicating the operating system version, service pack, and/or architecture. The data structure 416 may further comprise fields 451 indicating the availability of virtualization resources, such as a hypervisor and/or different virtual operating environments (e.g., Unix®, OSX®, and so on). The fields 452 may indicate the availability of memory resources on the computing device 104A-N. The fields 452 may indicate the amount of volatile memory available, memory consumption, virtual memory status, and so on. The fields 453 may indicate the availability of storage resources on the computing device 104A-N (e.g., non-volatile storage resources, such as hard drives, etc.). The fields 453 may indicate storage resource availability, protocol, bandwidth, and so on. The fields 454 may indicate the status of I/O resources, such as the availability of I/O buses, bus types, storage protocols (e.g., RAID, JBOD, etc.), and so on. Network fields 454 may indicate the availability of network communication resources, such as network interface(s), network bandwidth, supported protocols, and so on. Processor fields 455 may indicate the availability of processing resources, such as the processor architecture of the computing device 104A-N, cores, operating frequency, cache, and so on. Graphics fields 456 may indicate the availability of graphics processing resources.

The resource state data structure 416 may further comprise fields 457 pertaining to libraries which, inter alia, may be used to implement computing tasks on the computing device 104A-N. The libraries fields 457 may indicate the availability of various types of libraries including, but not limited to: graphics libraries, application libraries, processing libraries, database libraries, and so on. The fields 457 may further indicate library versioning, and so on. The applications fields 458 may indicate available applications on the computing device 104A-N (e.g., installed applications). The fields 458 may further indicate a version of the application(s), current application status (e.g., running, etc.), and so on.

In some embodiments, the resource state data structure 416 may comprise fields 459 configured to maintain information pertaining to computing tasks. The fields 459 may identify computing tasks that a user may wish to execute on the computing device 104A-N. The fields 459 may identify the computing resources required by various computing tasks, quality of service information (user preferences regarding resources for the computing tasks), and so on. The resource broker agent 102 may use information of the computing tasks fields 459 to determine whether the computing device 104A-N can implement a particular computing task at current resource availability levels, whether additional computing resources 118 are needed, and/or whether the computing task is to be executed remotely, or the like. Alternatively, or in addition, the resource broker agent 102 may be configured to determine computing requirements of various computing tasks by monitoring resource utilization information of the computing task, analyzing the computing task (e.g., checking dependencies of the computing task), or the like. The resource broker agent 102 may update the resource state data structure 416 based on information in the monitoring and/or analysis.

The resource state data structure 416 may further comprise fields 460 pertaining to one or more resource providers 117A-N. The fields 460 may comprise a catalog of resource providers 117A-N including, but not limited to: information pertaining to communication with the resource provider 117A-N (e.g., network address, protocol, service publication, etc.), security information (e.g., certificate, credentials, security protocols, etc.), computing resources 118 provided by the resource provider 117A-N, supported delivery and/or access mechanisms, pricing information, status (e.g., whether the resource provider 117A-N is currently available), and so on.

Referring back to FIG. 4A, the resource broker agent may comprise a rules engine 422 configured to determine how requests to perform computing tasks (monitored by the monitor module 402 and/or interrupt module 406) are to be fulfilled by, inter alia, applying static and/or dynamic rule sets to fields of the resource state data structure 416. The rules engine 422 may be configured to compare the computing resources available on the computing device 104A-N (per the resource state data structure 416) to computing resource requirements of the computing task (and/or computing resources required to provide a pre-determined quality of service). The rules engine 422 may be configured to apply one or more algorithms to identify when additional computing resources (including remote execution) are needed. For example, the rules engine 422 may compare the amount of storage space required to complete a computing task to the amount of available storage resources, and may request additional storage if required. In another example, the rules engine 422 may be configured to determine whether particular features and/or protocols are available on the computing device 104A-N. For instance, a computing task may require RAID storage services that are not natively available on the computing device 140A-N; in response, the rules engine 422 may broker access to such storage services from one or more resource providers 117A-N. The rules engine may be further configured to determine the type, quantity, format, and/or method for brokering the additional resources. The rules engine 422 may determine how the resources are to be delivered and/or accessed (e.g., RMI, RPC, SOAP, etc.), determine whether to implement the computing task using local resources or by remote execution, and so on.

In some embodiments, the resource broker agent 102 may further comprise an inference engine 438 configured to utilize heuristics, pattern matching, artificial intelligence, or other behavior-based technologies in order to update 444 the rules engine 422 and/or resource state data structure. The updates may comprise determining whether resources provided by one or more resource providers 117A-N provided adequate quality of service for a particular computing task, performance of a virtualization environment, performance of network access protocols (e.g., for remote execution), and so on.

In some embodiments, the resource broker agent 102 comprises a request module 424 configured to request 430 computing resources 118 from one or more resource providers 117A-N via the network 112 or other communication mechanism. The request module 424 may be configured to request additional computing resources 118 in response to the rules engine 422 determining that a requested computing task cannot be executed on the computing device 104A-N (and/or cannot provide sufficient quality of service) at current resource availability levels per the resource state data structure 416. The request module 424 may be configured to request computing resources 118 using a secure connection. The request module 424 may be further configured to broker a delivery and/or access mechanism for the requested computing resources 118, broker consideration for the requested computing resources 118, and so on.

The resource broker agent 102 may further comprise a listener module 436 configured to listen for the delivery 446 of brokered computing resources 118 from a resource provider 117A-N. The brokered computing resources 118 may be delivered to the computing device 104A-N by use of a delivery module 432. As described above, resource delivery may comprise providing access 420 to the brokered computing resources 118 of one or more resource providers 117A-N for execution of a requested computing task. Alternatively, or in addition, resource delivery may comprise providing access to remote execution of the requested computing task on one or more of the resource providers 117A-N. Accordingly, the listener and/or delivery modules 436, 432 may be configured to establish a secure communication channel between the computing device 104A-N and one or more resource providers 117A-N via the network 112 and/or other communication mechanism. The listener module 436 may be configured to coordinate transport of data pertaining to delivery of the computing resource(s), and the delivery module 432 may be configured to provide the computing device 104A-N with access to the delivered resource(s).

In some embodiments, the resource broker agent 102 is configured to maintain a catalog of resource providers 117A-N and the computing resources 118 provided thereby. The catalog may enumerate various different type of computing resources 118 provided by each resource provider 117A-N (e.g., capabilities of the resource providers 117A-N), pricing for the computing resources 118, delivery and/or access mechanisms supported by the resource providers 117A-N, and so on. The resource broker agent 102 may comprise a catalog updater module 418 that is configured to receive 426 updated catalog information from the resource providers 117A-N (and/or resource discovery service 119). In some embodiments, the catalog update module 418 is configured to automatically discover resource providers 117A-N and/or services provided by the resource providers 117A-N by use of a resource discovery service 119. The resource discovery service 119 may be configured to maintain a catalog of resource provides 117A-N available for use by the resource broker agent 102. The resource providers 117A-N and/or resource discovery service 119 may publish resource provider information using any suitable technique including, but not limited to: Extensible Markup Language (XML), Web Services Description Language (WSDL), Simple Object Access Protocol (SOAP), SOAP Service Description Language (SSDL), or the like. The catalog update module 418 may be configured to update the resource state data structure 416 in response to updates from the resource providers 117A-N.

The resource broker agent 102 may further comprise an interface module 408 configured to provide an interface to control, configure, and/or manage the resource broker agent 102. The interface module 408 may be configured to generate one or more graphical user interfaces, such as a management console 410, which may be configured to provide configuration, reporting, and/or auditing of the resource broker agent 102, and so on. The management console 410 may be adapted according to the computing device 104A-N on which the resource broker agent 102 is deployed. For example, in some embodiments, the management console 410 may be adapted for display on a smart phone and, in other embodiments; the management console 410 may be adapted for display on a tablet and/or desktop interface.

In some embodiments, the interface module 408 is configured to display available computing tasks (e.g., applications, services, etc.) that can be performed on the computing device 104A-N and/or can be performed by use of one or more of the resource providers 117A-N. Accordingly, the available computing tasks may include applications available on the computing device 104A-N (e.g., installed on the computing device 104A-N), applications available on one or more virtual computing environments of the computing device 104A-N, applications available for remote execution, and so on. The resource broker agent 102 may be configured to provide a launcher configured to invoke the computing tasks, as described herein.

As described above, the resource broker agent 102 may be configured to maintain and/or access a catalog of resource information published by the resource providers 117A-N and/or resource discovery service 119. The catalog may comprise information pertaining to the availability, fees or costs, features, capacity, delivery and/or access mechanisms, and/or other characteristics of the resource providers 117A-N. A user of the computing device 104A-N, or a third party utilizing the interface module 408 or management console 410 may utilize the catalog update module 418 to configure preferences or settings of the resource broker agent 102, such as when and what type of resources to broker.

In some embodiments, the interface module 408 may be configured to provide for presenting information pertaining to the resource providers 117A-N. A user, or other third-party, may set policy information, such as resource provider preferences, cost and/or payment policies, and so on. The rules engine may use the policy information to select resource provider(s) 117A-N, broker delivery and/or mechanisms, provide payment, and so on. A user of a computing device 104 may interact with the resource broker agent 102 by use of the interface module 408 and/or management console 410 in order to modify the policy information. The resource broker agent 102 may be configured to display status information through the interface module 408. For example, the resource broker agent 102 may indicate at such time that the resource broker agent 102 is brokering additional resources with one or more resource providers 117A-N and may prompt the user for acceptance of brokering terms, or the like. This notification(s) may provide an opportunity for a user of the computing device 104A-N to immediately interact with the resource broker agent 102 in order to influence the algorithms utilized by the resource broker agent 102 to affect current or future resource broker agent 102 functionality.

In some embodiments, the interface 408 includes a launcher 409 configured to display and/or provide for launching computing tasks available. The computing tasks may include software, applications, services, and/or application extensions available: on the computing device 104A-N (e.g., installed on the computing device 104A-N), available in one or more virtualized computing environments of the computing device 104A-N (e.g., virtual machines), available by use of computing resources of one or more of the resource providers 117A-N, and/or available by use of remote execution on one or more of the resource providers 117A-N. Accordingly, the launcher 409 may be configured to invoke computing tasks on the computing device 104A-N, within one or more virtual computing environments, and/or on one or more of the resource provider 117A-N.

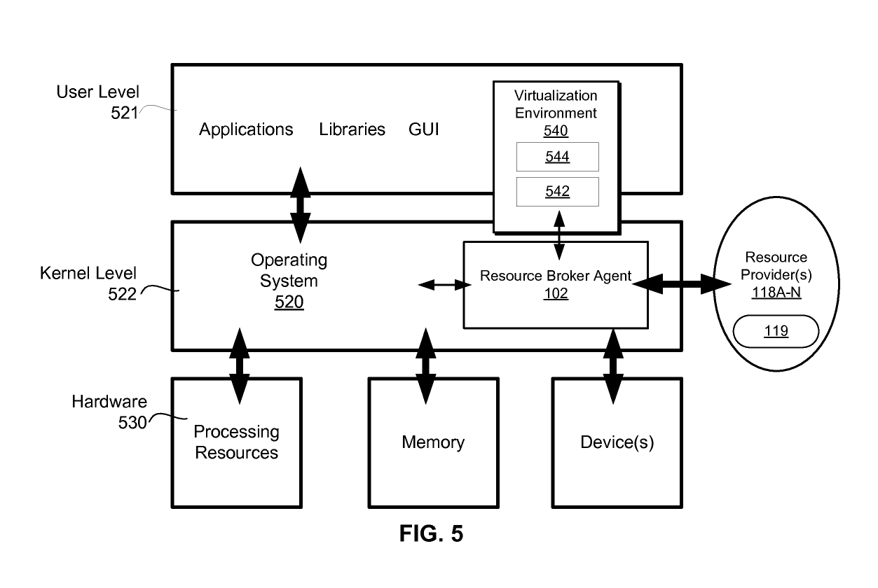

In some embodiments, the resource broker agent 102 is configured to operate locally on the computing device 104A-N, which may enable the resource broker agent 102 to run within the operating system of the computing device 104A-N (e.g., at a kernel level of the operating system). Operation within the computing device 104A-N may enable the resource broker agent 102 to broker computing resources 118 in real-time (e.g., at request and/or runtime for completion of a computing task), which may comprise monitoring resource availability on the computing device 104A-N, adjusting resources allocation information, and so on. In some embodiments, the resource broker agent 102 is further configured to reallocate resources between computing tasks. FIG. 5 depicts one embodiment of a resource broker agent 102 operating within a computing device 104A-N. As depicted in FIG. 5, an operating system 520 supports a user level 521 comprising applications, libraries, graphical user interfaces, and the like. The operating system 520 may control access to hardware resources 530 of the computing device 104A-N, which may include, but are not limited to processing resources, memory, and/or other devices. The operating system 520 may comprise a kernel level 522. The resource broker agent 102 (and/or portions thereof) may be configured to operate within the kernel level 522 of the operating system 520. Operation within the kernel level 522 may allow the resource broker agent 102 to monitor resource availability, resource consumption of user-level processes, requests to execute computing tasks, and so on. Operation within the computing device 104A-N may enable the resource broker agent 102 to maintain accurate resource state information (resource state data structure 416). The resource broker agent 102 may leverage the kernel level 522 to perform other functions, such as interrupting computing task requests, interrupting and/or modifying computing tasks, coordinating delivery of and/or access to computing resources 118 provided by the resource providers 117A-N, and so on.

In some embodiments, the resource broker agent 102 may be configured to implement certain computing tasks within isolated “containers” (e.g., virtual machines). The operating system 520 may comprise a virtualization environment 540, which may include a virtualization kernel and/or hypervisor 542. The virtualization environment 540 may comprise one or more virtualized computing environments (e.g., virtual machines 544), which may be used to perform computing tasks. The virtual machines 544 may be configured to execute computing tasks using different computing environments (e.g., different operating systems, architectures, etc.) not natively available on the computing device 104A-N.

In some embodiments, the resource broker agent 102 is configured to publish and/or invoke applications within the virtualization environment 540 (e.g., utilize one or more virtual machines 544). The resource broker agent 102 may be configured to execute a requested computing task using a virtual machine in response to determining that the operating system 520 of the computing device 140A-N is incompatible with the computing task, lacks libraries needed to execute the computing task, and/or the like. Accordingly, brokering additional resources may comprise brokering resources within the computing device 140A-N itself, without accessing network-accessible computing resources 118 and/or resource providers 117A-N.

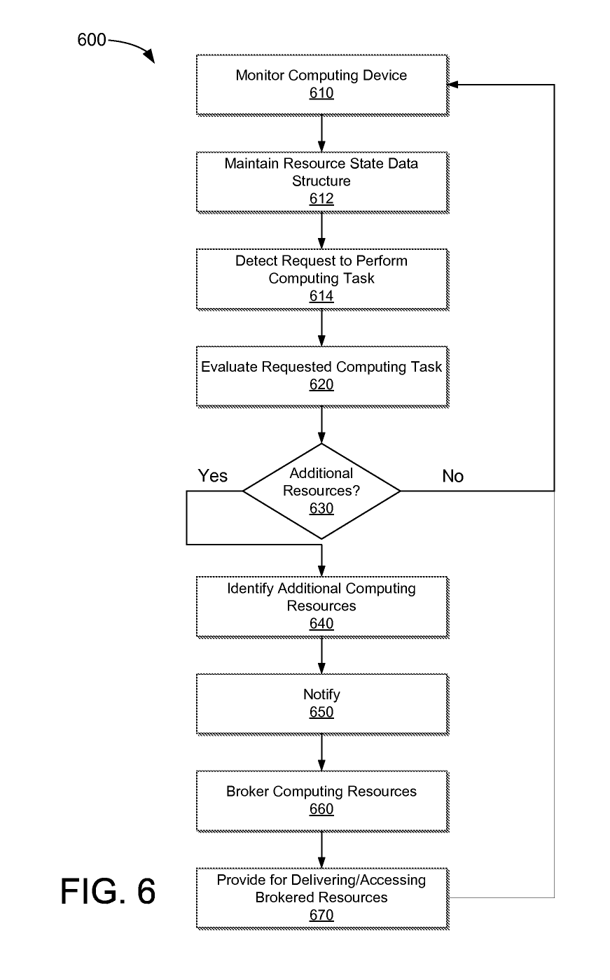

FIG. 6 is a flow diagram of another embodiment of a method for brokering computing resources. Step 610 may comprise monitoring a computing device 104A-N. Step 610 may comprise monitoring availability of computing resources, resource allocation information, and the like. Step 610 may further comprise monitoring operations performed on the computing device 104A-N (e.g., user commands and the like). Step 610 may be performed by a resource broker agent 102 operating at a kernel level of an operating system of the computing device 104A-N.

Step 612 may comprise maintaining a resource state data structure 416. Maintaining the resource state data structure may comprise maintaining one or more fields pertaining to availability of hardware and/or software resources on the computing device 104A-N, as described above. Step 612 may further comprise maintaining policy information pertaining to the resource broker agent 102. The policy information may include, but is not limited to: requirements of various computing tasks, quality of service preferences, settings and/or preferences pertaining to resource providers 117A-N, and so on. Accordingly, step 612 may comprise updating a catalog of resources available from the one or more resource providers 117A-N.

Step 614 may comprise detecting a request to perform a computing task on the computing device 104A-N. The request may be detected in the monitoring step 610 and/or by use of another monitoring process or entity.

Step 620 may comprise evaluating the requested computing task, which may comprise identifying resource requirements of the computing task, as described above. The evaluation of step 620 may be made in reference to information pertaining to the requested computing task in the resource state data structure 416 and/or may be based on analysis of the requested computing task (e.g., dependencies, operating system requests, and so on).

Step 630 may comprise determining whether to broker additional computing resources for the requested computing task. Step 630 may comprise the rules engine evaluating one or more preferences, rule sets, settings, and/or the like to compare the resources required by the requested computing task to the resources available on the computing device 104A-N. If additional computing resources are required, the flow continues at step 640; otherwise, the computing task is allowed to proceed as normal, and the flow continues back at step 610.

Step 640 may comprise identifying computing resources needed to implement the computing task. Step 640 may comprise comparing required computing resources of the computing task to available computing resources, as described above. Step 640 may further comprise determining whether the identified computing resources are available from one or more resource providers 117A-N, a cost of the resources, and so on. In some embodiments, step 640 further comprises comparing requests to broker additional computing resources 118 to enable execution of the computing task on the computing device 104A-N to executing the requested computing task remotely. For example, in some cases, it may be more efficient to broker remote execution of a computing task (in terms of cost and/or performance) than brokering the particular computing resources 118 needed to implement the computing task (and/or portions thereof) locally on the computing device 104A-N. Accordingly, step 640 may comprise identifying a plurality of different options for executing the computing task using, inter alia, a plurality of different resource providers 117A-N.

Step 650 may comprise notifying the user, or other entity, regarding the requirement for additional computing resources 118. Step 650 may comprise prompting the user to approve brokering the additional computing resources 118. The prompt may provide the user with various options, such as local versus remote execution, selection between one or more resource providers 117A-N, cost and/or pricing options, and the like. Step 650 may further comprise receiving approval to broker the computing resources 118 and/or acceptance of an offer to provide the additional computing resources 118 from one or more resource providers 117A-N. In some embodiments, step 650 may comprise an automatic notification (e.g., logging system) and approval for brokering the additional computing resources 118 may be received from the rules engine 422 and/or other entity.

Step 660 may comprise brokering the additional computing resources 118, as described above. Accordingly, step 660 may comprise transmitting one or more requests to one or more resource providers 117A-N, brokering the type, quantity, and/or delivery mechanism(s) for the computing resources 118, and so on.

Step 670 may comprise providing for executing the requested computing task by use of the brokered computing resources 118. Step 670 may comprise executing the computing task (and/or portions thereof) locally on the computing device 104A-N and/or executing the computing task (and/or portions thereof) remotely.

Reference throughout this specification to features, advantages, or similar language does not imply that all of the features and advantages that may be realized are included any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

The embodiments disclosed herein may involve a number of functions to be performed by a computer processor, such as a microprocessor. The microprocessor may be a specialized or dedicated microprocessor that is configured to perform particular tasks according to the disclosed embodiments, by executing machine-readable software code that defines the particular tasks of the embodiment. The microprocessor may also be configured to operate and communicate with other devices such as direct memory access modules, memory storage devices, Internet-related hardware, and other devices that relate to the transmission of data in accordance with various embodiments. The software code may be configured using software formats such as Java, C++, XML and other languages that may be used to define functions that relate to operations of devices required to carry out the functional operations related to various embodiments. The code may be written in different forms and styles, many of which are known to those skilled in the art. Different code formats, code configurations, styles and forms of software programs and other means of configuring code to define the operations of a microprocessor in accordance with the disclosed embodiments.

Within the different types of devices, such as laptop or desktop computers, hand held devices with processors or processing logic, and also possibly computer servers or other devices that utilize the embodiments disclosed herein, there exist different types of memory devices for storing and retrieving information while performing functions according to one or more disclosed embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to various embodiments when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured disclosed herein enable the physical transformation of these memory devices. Accordingly, the embodiments disclosed herein are directed to novel and useful systems and methods that, in one or more embodiments, are able to transform the memory device into a different state. The disclosure is not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

I claim:

1. A system for brokering computing resources, comprising:
a computing device comprising a processor, memory, and non-volatile storage; and
a resource broker agent operating on the computing device, wherein the resource broker agent is configured to detect a request to perform a computing task,
wherein the resource broker agent is configured to broker access to additional computing resources in response to identifying additional computing resources needed to perform the requested computing task.

2. The system of claim 1, wherein the resource broker agent is configured to request access to the additional computing resources from one or more resource providers via a network.

3. The system of claim 1, further comprising a launcher module, wherein the request to perform the computing task is received through the launcher module, and wherein the computing task pertains to an application that is not installed on the computing device.

4. The system of claim 1, wherein the resource broker agent comprises a request monitor module configured to monitor requests to perform computing tasks on the computing device.

5. The system of claim 4, wherein the monitor module is configured to operate within a kernel level of an operating system of the computing device.

6. The system of claim 1, wherein the resource broker agent comprises a resource monitor module configured to monitor currently available computing resources on the computing device, and wherein the resource broker agent is configured to identify the additional computing resources needed to perform the computing task based on the currently available computing resources.

7. The system of claim 6, wherein the resource monitor is configured to monitor availability of one or more of processing resources, memory resources, storage resources, input/output resources, graphics processing resources, operating system resources, and library resources.

8. The system of claim 1, wherein the resource broker agent comprises a resource monitor module configured to monitor libraries currently available on the computing device, and wherein the resource broker agent is configured to identify the additional computing resources needed to perform the computing task based on the currently available libraries.

9. The system of claim 8, wherein the resource monitor module is configured to monitor one or more of an operating system version, virtual machine version, hypervisor version, and library version.

10. The system of claim 1, wherein the resource broker agent is configured to broker one or more of a type, quantity, format, access method, and delivery method for the additional computing resources.

11. The system of claim 1, wherein the resource broker agent is configured to broker execution of at least a portion of the computing task in a virtual machine operating on the computing device.

12. The system of claim 1, wherein the resource broker agent is configured to broker remote execution of at least a portion of the computing task on one or more resource providers.

13. The system of claim 1, further comprising an interface module configured to notify a user of the computing device that additional resources are needed to perform the computing task.

14. The system of claim 1, wherein the resource broker agent is configured to maintain a resource state data structure comprising information pertaining to one or more of computing resources currently available on the computing device, computing resource requirements of one or more computing tasks, and a catalog of computing resources provided by one or more resource providers.

15. A method for brokering computing resources, comprising:
detecting a request to perform a computing task within an operating system of a computing device;
identifying additional computing resources needed to perform the requested computing task;
brokering access to the identified computing resources in response to detecting the request; and
providing for performing the requested computing task by use of the identified computing resources.

16. The method of claim 15, wherein brokering access comprises brokering remote execution of at least a portion of the requested computing task on one or more remote resource providers.

17. The method of claim 16, wherein providing for performing the requested computing task comprises displaying a result of the remote execution of the portion of the requested computing task on the computing device.

18. The method of claim 15, further comprising providing a launcher configured to present one or more computing tasks available to be performed by use of computing resources of one or more remote resource providers.

19. The method of claim 15, further comprising providing for performing at least a portion of the computing task within a virtual computing environment of the computing device.

20. The method of claim 15, further comprising monitoring computing resources availability on the computing device, wherein identifying the additional computing resources comprises comparing the available computing resources of the computing device to computing resource requirements of the requested computing task.

21. A computer-readable storage medium comprising instructions configured to cause a computing device to perform a method, comprising:
monitoring availability of computing resources within an operating system of a computing device;
detecting a request to execute a computing task on the computing device within the operating system of the computing device;
comparing the availability of computing resources to computing resources needed to execute the requested computing task;
identifying additional computing resources needed to execute the requested computing task based on the comparing;
brokering access to the additional computing resources; and
providing for executing the requested computing task by use of the brokered computing resources.
brokering access to the identified computing resources from one or more remote resource providers in response to detecting the request; and
providing for performing the requested computing task by use of the identified computing resources.
